(19) United States
(12) Patent Application Publication
(10) Pub. No.: US 2013/0260090 A1
(43) Pub. Date: Oct. 3, 2013

(54) RECESSED ADHESIVE BINDING SYSTEMS AND METHODS OF MAKING SAME

(71) Applicant: David C. Windorski, Woodbury, MN (US)

(72) Inventor: David C. Windorski, Woodbury, MN (US)

(73) Assignee: 3M Innovative Properties Company, St. Paul, MN (US)

(21) Appl. No.: 13/882,748

(22) PCT Filed: Dec. 20, 2011
(86) PCT No.: PCT/US11/65956

§ 371 Date: May 1, 2013

Related U.S. Application Data
(60) Provisional application No. 61/425,838, filed on Dec. 22, 2010.

(51) Int. Cl. B42D 3/00

(52) U.S. Cl. CPC B42D 3/002
USPC 428/122; 156/227; 428/131

(57) ABSTRACT

Recessed adhesive binding systems and methods of making same. One system can include a sheet having front and rear surfaces, and an adhesive on the rear surface. The sheet can include at least one opening and at least one folded section. The at least one folded section can include a first and second portion of the sheet separated by a fold. At least one of the first portion and the second portion of each folded section can include at least one opening, such that when the rear surfaces of the first and second portion are adhered together, the adhesive is exposed across the at least one opening and recessed from the front surface of the sheet, forming at least one recessed adhesive zone. One method can include forming at least one opening through the sheet, and folding the sheet to form at least one folded section.

### FIELD

The present disclosure generally relates to binding systems that can be used for filing, organizing and/or displaying elements, such as paper, and particularly, to binding systems employing recessed adhesive zones that can be selectively activated, and more particularly, to binding systems employing recessed adhesive zones formed of a single sheet.

### BACKGROUND

Some existing binders, or binding systems, use metal or plastic brackets, brads, or the like to file, organize, or display sheets of paper in a desired manner. Such binders typically require holes to be punctured in the sheets of paper. Other binding systems may allow paper to be slid between two rigid and opposing surfaces without puncturing the paper; however, such binding systems typically cannot support very many sheets of paper. In addition, with some binding systems, it can be cumbersome or difficult to rearrange the paper after it has been bound with the binding system.

In addition, some articles employing recessed adhesive areas require multiple layers of material for an adhesive of a backing layer to be exposed across openings formed in a front layer.

### SUMMARY

The recessed adhesive binding systems of the present disclosure afford easy-to-use and attractive filing, organizing, and/or displaying of various articles, such as paper, envelopes, or the like. The binding systems can allow for facile re-arrangement of items after the items have been bound with the binding system, and can bind various items without damaging such items. Furthermore, the binding systems of the present disclosure can be formed of a single sheet that includes a rear adhesive surface, one or more openings, and one or more folded sections configured to expose the rear adhesive surface through the one or more openings. In some embodiments, the binding systems can be employed as wall hangings for organizing and/or displaying tasks; to-do lists; projects; notes; envelopes comprising articles such as coins, stamps, or the like; as well as other suitable items desired to be organized and/or displayed. In addition, in some embodiments, the binding systems can be employed in folders, such as file folders, hanging files, or the like, in which the items to be displayed can be arranged in a book configuration.

Some embodiments of the present disclosure provide a recessed adhesive binding system. The system can include a sheet having a front surface and a rear surface, and can have a pressure-sensitive adhesive on the rear surface. At least one opening can be formed through the sheet, and at least one folded section can be formed in the sheet. The at least one folded section can include a first portion of the sheet and a second portion of the sheet separated by a fold. The rear surface of the first portion can be adhered to the rear surface of the second portion, and at least one of the first portion and the second portion can include at least one opening, such that when the first portion and the second portion are adhered together, the pressure-sensitive adhesive is exposed across the at least one opening and recessed from the front surface of the sheet, forming at least one recessed adhesive zone in the at least one folded section.

Some embodiments of the present disclosure provide a recessed adhesive binding system. The system can include a sheet having a front surface and a rear surface, and can have a pressure-sensitive adhesive on the rear surface. The sheet can have a length and a width, and a plurality of openings formed through the sheet. The system can further include a plurality of folded sections formed in the sheet. Each of the plurality of folded sections can include a first portion of the length of the sheet and a second portion of the length of the sheet separated by a fold. The fold can extend along the width of the sheet. The rear surface of the first portion can be adhered to the rear surface of the second portion, and at least one of the first portion and the second portion of each folded section can include at least one opening positioned along its width, such that when the first portion and the second portion are adhered together, the pressure-sensitive adhesive is exposed across the at least one opening and recessed from the front surface of the sheet, forming at least one recessed adhesive zone along the width of each of the plurality of folded sections. The plurality of folded sections can be arranged such that the second portion of at least one of the plurality of folded sections is positioned adjacent a first portion of an adjacent folded section.

Some embodiments of the present disclosure provide recessed adhesive binding system. The system can include a sheet having a front surface and a rear surface, and can have a pressure-sensitive adhesive on the rear surface. The sheet can have a length and a width, and a plurality of openings formed through the sheet. The system can further include a plurality of folded sections formed in the sheet. Each of the plurality of folded sections can include a first portion of the length of the sheet and a second portion of the length of the sheet separated by a fold. The fold can extend along the width of the sheet, and the rear surface of the first portion can be adhered to the rear surface of the second portion. At least one of the first portion and the second portion of each folded section includes at least one opening positioned along its width, such that when the first portion and the second portion are adhered together, the pressure-sensitive adhesive is exposed across the at least one opening and recessed from the front surface of the sheet, forming at least one recessed adhesive zone along the width of each of the plurality of folded sections. Each of the plurality of folded sections can define a living hinge between the folded section and another portion of the sheet. At least two adjacent folded sections of the plurality of folded sections can be spaced a distance apart along the length of the sheet, such that the rear surface of the sheet between the at least two adjacent folded sections is exposed.

Some embodiments of the present disclosure provide a method of making a recessed adhesive binding system. The method can include providing a sheet having a front surface and a rear surface, and having a pressure-sensitive adhesive on the rear surface. The method can further include forming at least one opening through the sheet, and folding the sheet to form at least one folded section. The at least one folded section can include a first portion of the sheet and a second portion of the sheet separated by a fold. The rear surface of the first portion can be adhered to the rear surface of the second portion. At least one of the first portion and the second portion can include at least one opening, such that when the first portion and the second portion are adhered together, the pressure-sensitive adhesive is exposed across the at least one opening and recessed from the front surface of the sheet, forming at least one recessed adhesive zone in the at least one folded section.

Other features and aspects of the present disclosure will become apparent by consideration of the detailed description and accompanying drawings.

### BRIEF DESCRIPTION OF THE DRAWINGS

FIG. 1 is a perspective view of a recessed adhesive binding system according to one embodiment of the present disclosure, the binding system including a folded section, shown unassembled.

FIG. 2 is a perspective view of the recessed adhesive binding system of FIG. 1 with the folded section shown assembled.

FIG. 3 is a side cross-sectional view of the recessed adhesive binding system of FIG. 2, taken along line 3-3 of FIG. 2.

FIG. 4 is a perspective view of a recessed adhesive binding system according to another embodiment of the present disclosure.

FIG. 5 is a perspective view of a recessed adhesive binding system according to another embodiment of the present disclosure, the recessed adhesive binding system employed as a wall display.

FIG. 6 is a perspective view of a recessed adhesive binding system according to another embodiment of the present disclosure, the recessed adhesive binding system employed as a hanging file.

FIG. 7 is a perspective view of a recessed adhesive binding system according to another embodiment of the present disclosure, the recessed adhesive binding system employed as a file folder.

FIG. 8 is a perspective view of a recessed adhesive binding system according to another embodiment of the present disclosure, the recessed adhesive binding system employed as a wall display.

FIGS. 9 illustrates a method of making a recessed adhesive binding system according to one embodiment of the present disclosure.

### DETAILED DESCRIPTION

Before any embodiments of the present disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “supported,” and “coupled” and variations thereof are used broadly and encompass both direct and indirect mountings, supports, and couplings. It is to be understood that other embodiments may be utilized, and structural or logical changes may be made without departing from the scope of the present disclosure. Furthermore, terms such as “front,” “rear,” “first,” “second,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

The present disclosure generally relates to a recessed adhesive binding system, which can be formed by folding a sheet (e.g., a single sheet) that has a pressure-sensitive adhesive on its rear surface such that two portions of the adhesive rear surface contact one another. One of the portions can have an opening formed therein, such that when the two portions are folded together, the adhesive on the rear surface of one portion is exposed across the opening in the other portion. Together, the two portions, separated by a fold, can form a folded section. The exposed adhesive is generally recessed from the front surface of the portion having the opening. As a result, an object or article (e.g., a sheet of paper) can be bound by the adhesive binding system by pressing one or both of the recessed adhesive and the object into contact across the opening. Because the adhesive is recessed, it is selectively activated in that it does not substantially bind to objects until desired, and until activated (e.g., pressed).

The adhesive binding systems of the present disclosure can be used in a variety of applications, including but not limited to, one or more of hanging files, file folders, in purses, in wallets, as a wallet organizer for credit cards, inside three-ring binders, as wall displays or organizers, in desk drawers, in books (e.g., textbooks), as a refrigerator door organizer, in lockers, other suitable applications, or combinations thereof. For example, the binding systems of the present disclosure can be used to organize a variety of objects, such as papers, shopping coupons, notes or messages, tasks, to-do lists, calendars, projects, recipe cards (e.g., while cooking), other suitable objects, or combinations thereof. In some embodiments, the binding systems can be color-coded, for example, such that multiple binding systems can be employed at one time, each binding system designated for a different use, purpose, project, or the like.

The adhesive binding systems of the present disclosure can hold a variety of lightweight articles, materials or items, including, but not limited to, one or more of papers, photographs, envelopes, newspaper articles, credit cards, paperclips, coins, stamps, thumbtacks, writing utensils, erasers, small tools (e.g., small screwdrivers or Allen wrenches), fasteners (e.g., nails, screws, brads, rivets, etc.), art supplies (e.g., crayons, colored pencils, paintbrushes, etc.), coupons, bills, other suitable lightweight articles, or combinations thereof. In some embodiments, a “lightweight” article is one that weighs less than about 50 g, in some embodiments, less than about 20 g, in some embodiments, less than about 10 g, and in some embodiments, less than about 5 g.

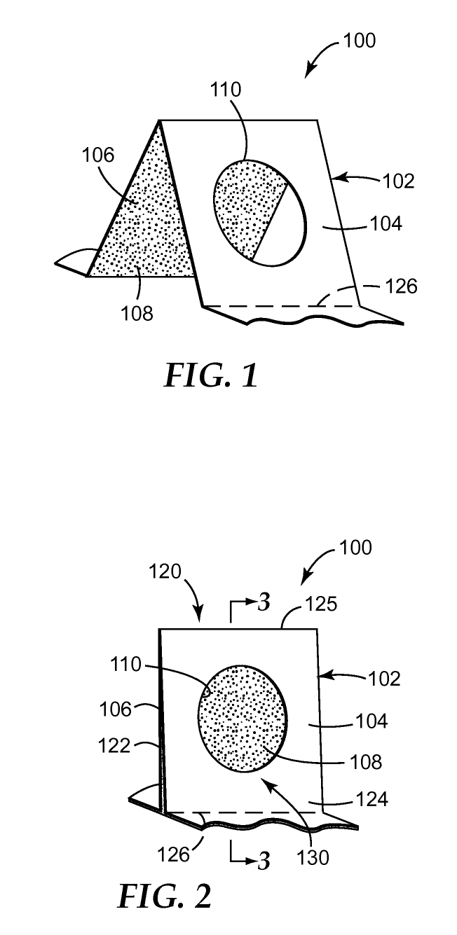

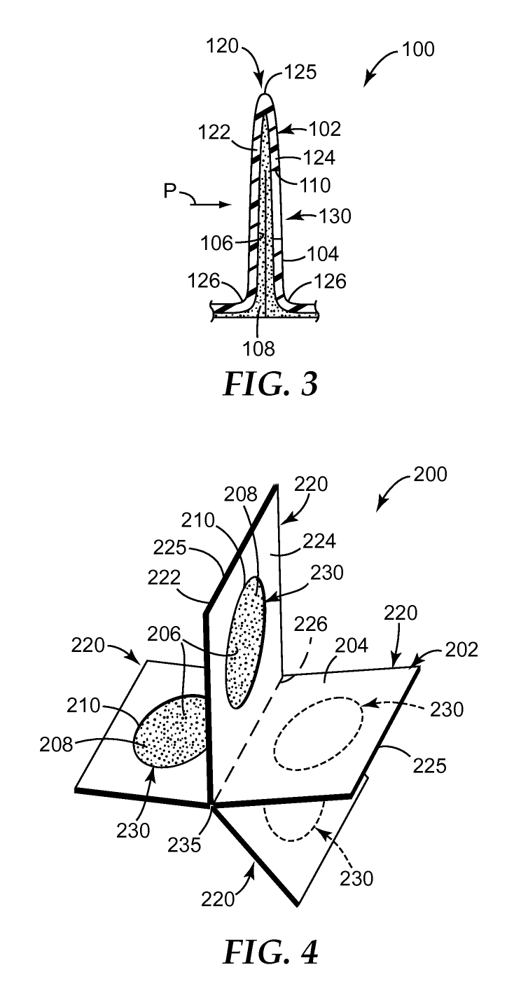

FIGS. 1-3 illustrate a recessed adhesive binding system 100 according to one embodiment of the present disclosure. The recessed adhesive binding system 100 is an example of the recessed adhesive binding system of the present disclosure in its simplest form. FIG. 1 shows the recessed adhesive binding system 100 unassembled, and FIGS. 2 and 3 show the recessed adhesive binding system assembled. Other recessed adhesive binding systems are disclosed in U.S. Patent Application No. 61/425,831, filed Dec. 22, 2010, the disclosure of which is incorporated herein by reference in its entirety. Examples of types of recessed adhesives that can be employed in the recessed adhesive binding systems of the present disclosure are described in U.S. Pat. No. 7,326,453 (Windorski), the disclosure of which is incorporated herein by reference in its entirety.

As shown in FIGS. 1-3, in some embodiments, the recessed adhesive binding system 100 can include a sheet 102 having a front surface 104, a rear surface 106, and having a pressure-sensitive adhesive 108 on the rear surface 106. In some embodiments, at least to facilitate fabricating the recessed adhesive binding system 100, the pressure-sensitive adhesive 108 can be coextensive with the sheet 102 (e.g., with the rear surface 106 of the sheet 102). The recessed adhesive binding system 100 can further include one or more openings or cutaway zones 110 formed through the sheet 102. In addition, as shown in FIGS. 2 and 3, the recessed adhesive binding system 100 can include one or more folded sections 120 formed in the sheet 102. In some embodiments, the number of folded sections 120 can dictate how many articles can be bound in one recessed adhesive binding system 100, and generally how “thick” the recessed adhesive binding system 100 is.

The sheet 102 can be formed of a variety of materials, including, but not limited to, one or more of paper, cardstock, cardboard, plastic film, other suitable materials, or a combination or laminate thereof. In some embodiments, the front surface 104 of the sheet 102 can be colored (e.g., stained, coated, dyed, etc.) for an attractive appearance, for example, that affords high contrast to the recessed adhesive binding system 100 and articles to be bound, mounted, and/or displayed by the recessed adhesive binding system 100.

The opening 110 shown in the embodiment of FIGS. 1-3 includes one full, circular opening, such that the material of the sheet 102 is present on all sides of the opening 110. In some embodiments, such a circular opening can have a diameter of at least about 2.5 cm, in some embodiments, at least about 1.5 cm, and in some embodiments, at least about 1 cm. However, it should be understood that a variety of openings 110 can be employed in which no sheet material is present on at least one side of the opening 110. For example, in some embodiments, the opening 110 can open to an edge or side of the sheet 102, such that sheet material is not present on all sides of the opening 110, and can form more of a “cutaway zone.” In some embodiments, the sheet 102 is formed of paper, and the opening 110 can be referred to as a “paperless zone.” A variety of shapes of openings 110 can be employed in the recessed adhesive binding system 100, including, but not limited to, triangles, rectangles, squares, ovals, oblong-shaped openings, semi-circles, trapezoids, polygons, waves, grooves, notches, scallops (e.g., scalloped edges), other suitable shapes, or combinations thereof.

As shown in FIGS. 2 and 3, each folded section 120 can include a first portion 122 of the sheet 102 and a second portion 124 of the sheet 102 separated by a fold 125, and in the assembled folded section 120, the rear surface 106 of the first portion 122 of the sheet 102 can be adhered to the rear surface 106 of the second portion 124 of the sheet 102. In the embodiment illustrated in FIGS. 1-3, the second portion 124 includes the opening 110, but at least one of the first portion 122 and the second portion 124 can include one or more openings 110, such that when the first portion 122 and the second portion 124 are adhered together (i.e., such that their rear surfaces 106 are adhered together), the pressure-sensitive adhesive 108 is exposed across the one or more openings 110 and recessed from the front surface 104 of the sheet 102, forming at least one recessed adhesive area, region, or zone 130 in the at least one folded section 120. In embodiments in which an opening, or cutaway zone, 110 is employed, the opening 110 may extend across the fold 125 of the folded section 120 (or across another edge of the sheet 102); however, by way of example only, the opening 110 of the embodiment of FIGS. 1-3 is fully contained within the second portion 124 of the folded section 120.

As shown in FIGS. 1-3, the recessed adhesive binding system 100 can be formed from a single sheet 102, having an adhesive 108 on its rear surface 106. In addition, as shown, in some embodiments, the sheet 102 itself can be formed of a single layer.

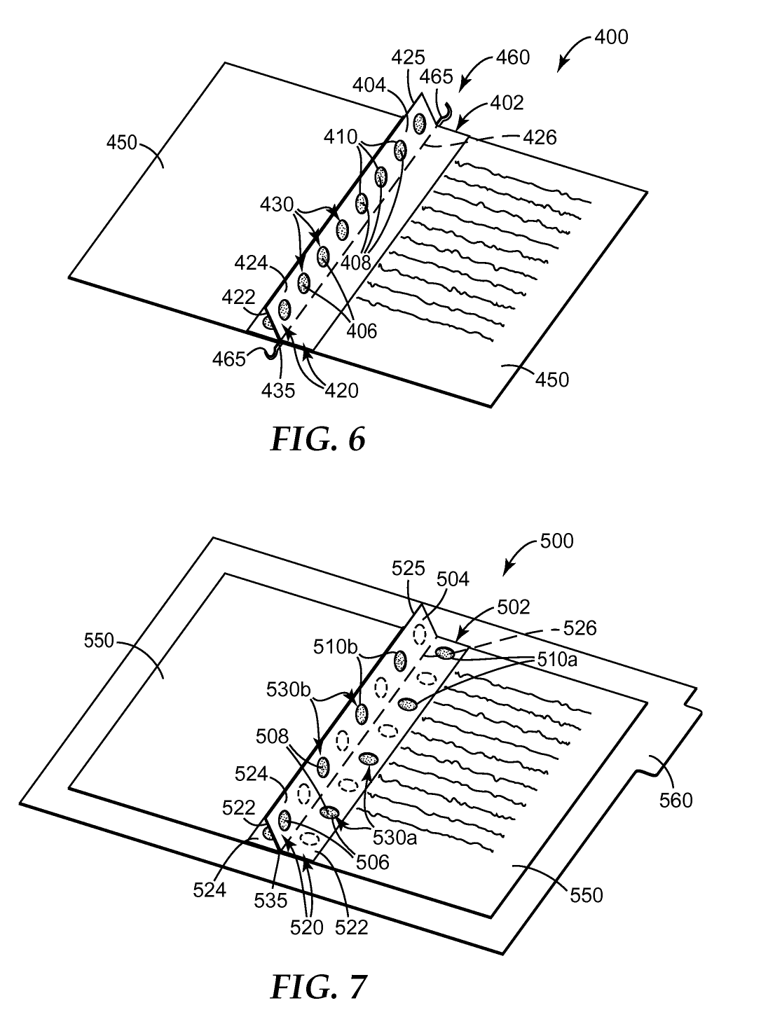

The one opening 110 and one recessed adhesive zone 130 in FIGS. 1-3 are shown by way of example and simplicity; however, it should be understood that each folded section 120 can include as many openings 110 and recessed adhesive zones 130 as necessary and structurally possible, which can be arranged in a variety of configurations to achieve the desired adhesiveness in the recessed adhesive binding system 100. For example, in some embodiments, the recessed adhesive binding system 100 can include a plurality of openings 110 and recessed adhesive zones 130 formed along a width of each folded section 120 (e.g., the dimension of the recessed adhesive binding system 100 going into and out of the page of FIG. 3). Examples of such embodiments are shown in FIGS. 6-9 and described below. In addition, the sheet 102 is shown broken along its length to signify that the sheet 102 could extend further along its length, for example, to form additional folded sections 120, and to have additional openings 110 and recessed adhesive zones 130 formed along its length.

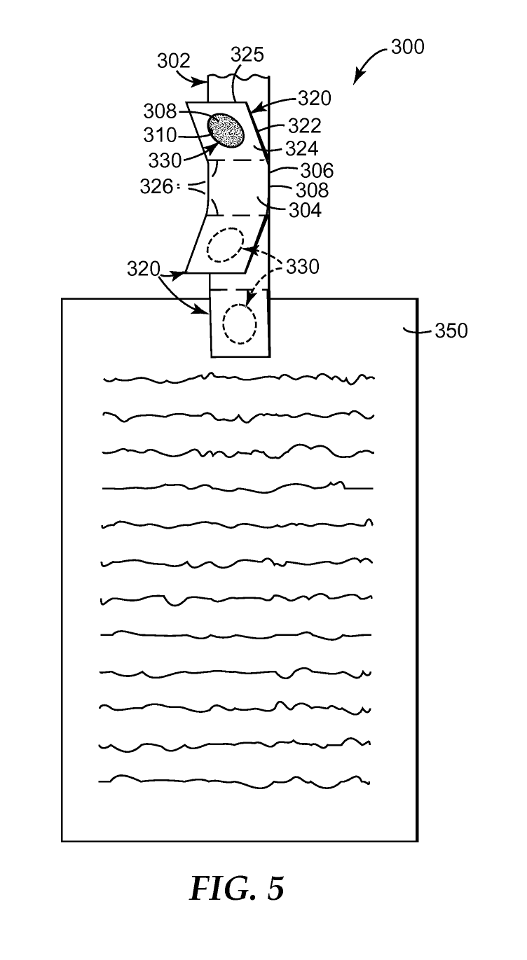

As further shown in FIGS. 1-3, in some embodiments, the sheet 102 can be folded again at the folded section 120, such that the folded section 120 is separated from the remainder (or another portion) of the sheet 102 by a living hinge 126 about which the folded section 120 can be pivoted and moved, for example, to bind various articles between adjacent folded sections 120 (see, e.g., FIGS. 4, 6, 7 and 8, which are described below), or between the folded section 120 and an adjacent portion of the sheet 102 (e.g., between the folded section 120 and an adjacent portion of the front surface 104 of the sheet 102—see, e.g., FIG. 5, which is described below).

The recessed adhesive zones 130 of the present disclosure can also be referred to as “selectively activated” adhesive areas or zones. Because the adhesive 108 is recessed from the front surface 104 of the sheet 102 in the one or more recessed adhesive zones 130, the adhesive 108 does not adhere to a surface or object positioned adjacent the front surface 104 of the sheet 102 until the recessed adhesive 108 is activated, e.g., until the recessed adhesive zone 130 is pressed toward that surface or object. For example, the first portion 122 of a folded section 120 can be pressed to pivot the folded section 120 about its living hinge 126 and to press the adhesive 108 through the opening 110 and into contact with the surface or object.

In some embodiments, the adhesive 108 can be recessed from the front surface 104 of the sheet 102 at least partially because the height of the adhesive 108 is less than the thickness of the sheet 102. That is, the thickness of the sheet 102 can be sufficient to space or separate the exposed adhesive 108 on the rear surface 106 of the first portion 122 from another surface or object contacting the front surface 104 of the second portion 124. In some embodiments, the sheet 102 can have a thickness of at least about 0.05 mm, in some embodiments, at least about 0.07 mm, in some embodiments, at least about 0.1 mm, and in some embodiments, at least about 0.25 mm.

As a result, the folded section 120 can be handled and moved across another surface such as a sheet of paper, a desktop, a countertop, or other adjacent folded sections 120 without adhering thereto via the exposed adhesive 108, or without adhering thereto until the recessed adhesive zone 130 is activated. This non-stick feature can also be dependent, to some degree, upon the fact that the sheet 102 has sufficient strength and/or rigidity so as not to sag appreciably (if at all) into any of the openings 110 across which it extends, even though it is unsupported across the cutaway openings 110. The size of the openings 110 can also be controlled to control the “sticky-ness” of the folded section 120. For example, in some embodiments, relatively small (e.g., no greater than 1 cm across) openings 110 can be employed, and in such embodiments, a larger number of openings 110 can be employed. The ability of the recessed adhesive binding system 100 to adhere to various articles or objects thereto can be dictated by the total or overall surface area of exposed and recessed adhesive 108, which can be controlled by controlling the size and/or number of recessed adhesive zones 130.

Activating the recessed adhesive 108 can be manual, such as by pressing against the first portion 122 of the folded section 120 with the fingers, palm, or hand of a user, for example, in a direction toward the second portion 124 of the folded section 120, generally denoted as P (see FIG. 3). While the adhesive 108 is activated to be adhered to another surface, the sheet 102 may deform on its front surface 104, although the deformation may not be visually or tactilely appreciable to the user.

The direction of pressure P in FIG. 3 is shown by way of example only; however, it should be understood that pressure P can instead be applied in a direction generally opposite the illustrated direction of P in FIG. 3. For example, a supported article can be pressed in a direction generally opposite that of P until the supported article (and/or the sheet 102) flexes and/or deforms enough to allow the adhesive 108 to contact and adhere to the supported article. In some embodiments, a combination of pressures in opposing directions and deformations of both the sheet 102 and the supported article can be employed to activate the adhesive 108.

As shown in FIGS. 2 and 3, in some embodiments, the recessed adhesive binding system 100 can include exposed adhesive 108 on its rear surface 106, for example, in regions not occupied by a folded section 120. Such exposed adhesive areas can be used to couple the recessed adhesive binding system 100 to other surfaces (e.g., mounting surfaces), such as walls, folders, etc., which will be described in greater detail below. In such embodiments, the recessed adhesive binding system 100 can include a release, or releasable, liner coupled to its exposed rear surface 106, prior to use.

In some embodiments, the pressure-sensitive adhesive 108 on the rear surface 106 of the sheet 102 can provide good adhesion to a surface (e.g. when the recessed adhesive binding system 100 includes exposed adhesive 108 on its rear surface 106), while also being removable under moderate force without leaving a residue (e.g., removable and/or repositionable pressure-sensitive adhesives). As a result, in some embodiments, articles that are bound or supported by the recessed adhesive binding system 100 can be easily removed, reorganized, reoriented, repositioned, and/or rearranged in the recessed adhesive binding system 100.

Examples of suitable materials for the adhesive 108 include one or more adhesives based on (meth)acrylates, urethanes, silicones, epoxies, rubber based adhesives (including natural rubber, polyisoprene, polyisobutylene, and butyl rubber, block copolymers, and thermoplastic rubbers), and combinations thereof.

Examples of suitable (meth)acrylates include polymers of alkyl acrylate monomers such as methyl methacrylate, ethyl methacrylate, n-butyl methacrylate, methyl acrylate, ethyl acrylate, n-butyl acrylate, iso-octyl acrylate, iso-nonyl acrylate, 2-ethyl-hexyl acrylate, decyl acrylate, dodecyl acrylate, n-butyl acrylate, hexyl acrylate, and combinations thereof. Examples of commercially available block copolymers include those available under the trade designation “KRATON G-1657” from Kraton Polymers, Westhollow, Tex.

As described above, in some embodiments, the adhesive 108 can include a removable and/or repositionable pressure-sensitive adhesive. An adhesive is considered to be “removable,” if after final application to an intended substrate, recessed adhesive binding system 100 can be removed at the end of the intended life of the article at a rate in excess of 7.62 meters/hour (25 feet/hour) by hand with the optional use of heat without damage to either the surface to which it is coupled (e.g., a mounting surface). In some embodiments, the removable pressure-sensitive adhesive has a 180 degree peel strength (from a sheet of 400-gauge Mylar D PET film, available from the E. I. du Pont de Nemours and Company, Wilmington, Del.) of less than 8 N/cm, and more particularly, less than 6 N/cm.

The term “repositionable” generally refers to the ability to be, at least initially, repeatedly adhered to and removed from a surface without substantial loss of adhesion capability. In some embodiments, the repositionable pressure-sensitive adhesive has a 180 degree peel strength, at least initially, of less than about 2 N/cm, in some embodiments, less than about 1 N/cm, and in some embodiments, less than about 0.1 N/cm, when peeled from a sheet of 400-gauge Mylar D PET film, available from the E. I. du Pont de Nemours and Company, Wilmington, Del.

Examples of suitable removable and repositionable pressure-sensitive adhesives include those described in Hobbs et al., U.S. Publication No. 2005/0249791 and Cooprider et al., U.S. Pat. No. 5,571,617, both of which are incorporated herein by reference; and adhesives based on solid inherently tacky, elastomeric microspheres, such as those disclosed in Silver, U.S. Pat. No. 3,691,140, Merrill et al., U.S. Pat. No. 3,857,731, and Baker et al., U.S. Pat. No. 4,166,152; all of which are incorporated herein by reference. Other removable and repositionable pressure-sensitive adhesives that can be employed in the present disclosure include those employing the composite pressure-sensitive adhesive microspheres disclosed in Kesti et al., U.S. Pat. No. 5,824,748, which is incorporated herein by reference.

In some embodiments, the adhesive 108 can be substantially smooth. In some embodiments, the adhesive 108 can be textured or include a topography. A topography can be beneficial for bleeding air out from beneath the sheet 102 as it is applied to a surface, thereby reducing the amount of trapped air pockets beneath the sheet 102. Examples of suitable topographies are discussed in Sher et al., U.S. Pat. No. 6,911,243, which is incorporated herein by reference.

In some embodiments, the thickness of the adhesive 108 can be at least about 10 micrometers, in some embodiments, at least about 20 micrometers, and in some embodiments, at least about 50 micrometers. In some embodiments, the thickness of the adhesive 108 can be no greater than about 300 micrometers, in some embodiments, no greater than about 200 micrometers, and in some embodiments, no greater than about 100 micrometers.

FIG. 4 illustrates a recessed adhesive binding system 200 according to another embodiment of the present disclosure, wherein like numerals represent like elements. The recessed adhesive binding system 200 shares many of the same elements and features described above with reference to the illustrated embodiment of FIGS. 1-3. Accordingly, elements and features corresponding to elements and features in the illustrated embodiment of FIG. 4 are provided with the same reference numerals in the 200 series. Reference is made to the description above accompanying FIGS. 1-3 for a more complete description of the features and elements (and alternatives to such features and elements) of the embodiment illustrated in FIG. 4. Any of the features described with respect to the embodiment of FIGS. 1-3 can equally be applied to the embodiment of FIG. 4.

The recessed adhesive binding system 200 includes a sheet 202 having a front surface 204 and a rear surface 206, and having a pressure-sensitive adhesive 208 on the rear surface 206. As shown in FIG. 4, the sheet 202 is folded into a plurality of folded sections 220 (four are shown by way of example only), each folded section 220 having an opening 210 and a recessed adhesive zone 230. In addition, the sheet 202 of the embodiment of FIG. 4 is sized (e.g., along its length) such that no additional portions of the sheet 202 extend beyond the four folded sections 220.

In some embodiments, as shown in FIG. 4, the sheet 202 can include a plurality of openings 210 spaced apart along its length, and can be folded uniformly along its length (e.g., along a central or longitudinal axis), such that the folded sections 220 are arranged about a common spine or binding 235 and are separated by living hinges 226, but not by additional unfolded sections of the sheet 202. As shown in FIG. 4, in some embodiments, the living hinges 226 of the folded sections 220 can be arranged such that they are substantially collinear (e.g., or positioned directly adjacent one another) and generally fall along or create the spine or binding 235 of the recessed adhesive binding system 200. As such, the recessed adhesive binding system 200 includes a “fan,” “book,” or “binder” configuration, such that the sheet 202 includes little to no length between adjacent folded sections 220, and such that a supported article or element (e.g., a sheet of paper) can be positioned between two adjacent folded sections 220, and can be adhered to at least one of the folded sections 220 between which it is positioned.

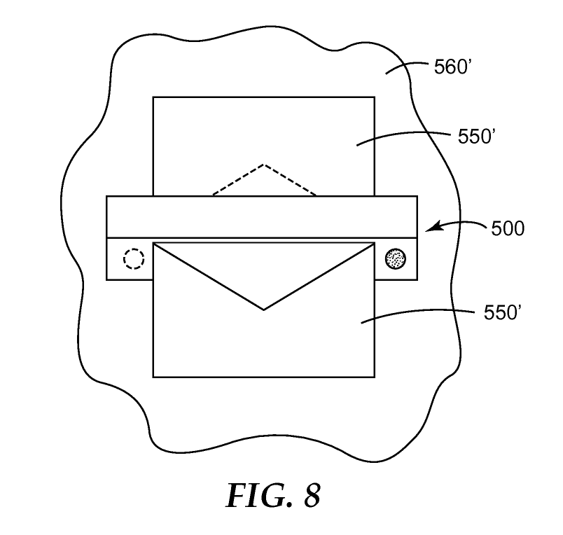

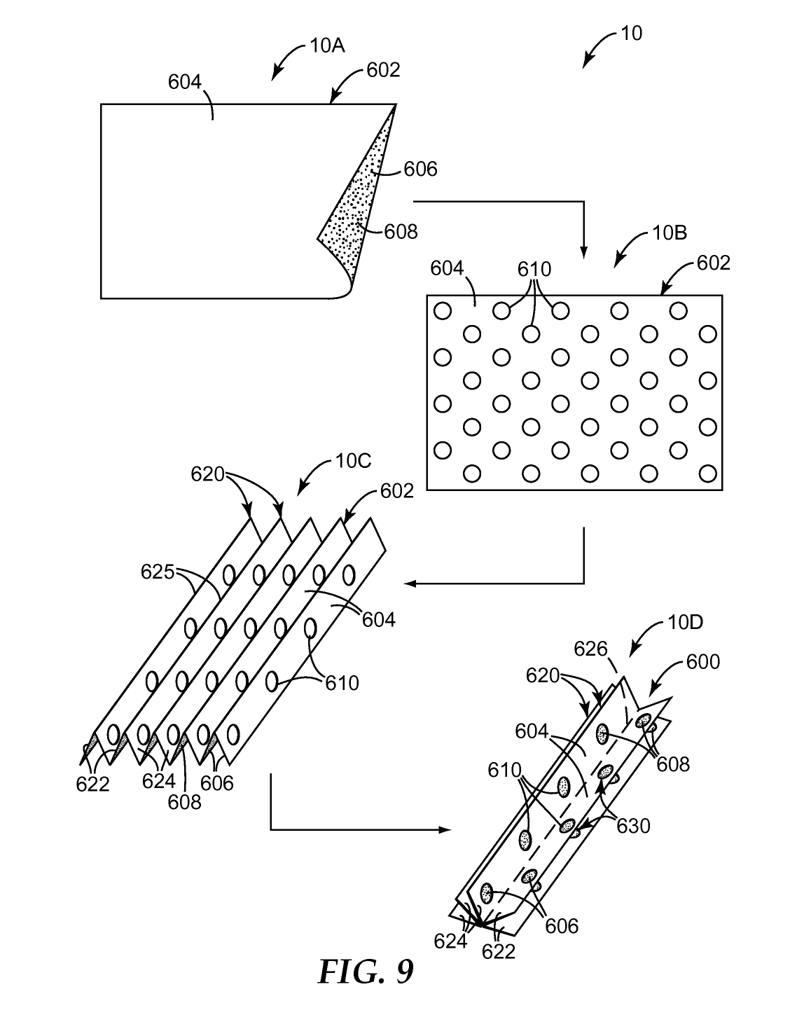

In the embodiment shown in FIG. 4, each folded section includes a first portion 222 and a second portion 224 separated by a fold 225, and only the second portion 224 of each folded section 220 includes the opening 210 and recessed adhesive zone 230. As such, a supported article would be adhered to only one folded section 220 when positioned between two adjacent folded sections 220. Specifically, when the supported article is positioned between adjacent folded sections 220, it would be positioned between a second portion 224 of a first folded section 220 and a first portion 222 of a second folded section 220, and would be adhered only to the second portion 224 of the first folded section 220. However, in some embodiments, the first portion 222 and the second portion 224 of each of the folded sections 220 can each include openings 210 and recessed adhesive zones 230, such that a supported article can be adhered to both folded sections 220 between which it is positioned (i.e., adhered to the second portion 224 of the first folded section 220 and adhered to the first portion 222 of the second folded section 220). The supported article can be adhered to the adhesive 208 when one or more recessed adhesive zones 230 are activated (e.g., pressed). Such embodiments are shown in FIGS. 8 and 9, which are described in greater detail below.

As further shown in FIG. 4, in some embodiments, each of the folded sections 220 can be configured such that the adhesive 208 of a recessed adhesive zone 230 of one folded section 220 is exposed to the front surface 204 of an adjacent folded section 220 (i.e., except for the end folded section 220). When the folded sections 220 are collapsed upon one another (e.g., by pivoting or folding the folded sections 220 about the living hinges 226), the adhesive 208 of each folded section 220 of the embodiment of FIG. 4 is positioned adjacent the front surface 204 of the adjacent folded section 220. In addition, when the folded sections 220 are collapsed, the folded sections 220 can be collapsed directly on top of one another, such that only the front surface 204 of the first folded section 220 is visible.

In some embodiments, the front surface 204 of the sheet 202 and/or the rear surface 206 of the sheet 202 can be configured such that the rear surface 206 adheres (or adheres well) to the rear surface 206 of another portion of the rear surface 206 of the sheet 202, but does not adhere (or does not adhere well) to the front surface 204 of the sheet 202. That is, in some embodiments, the adhesive 208 and/or the front surface 204 of the sheet 202 can be configured such that the adhesive 208 does not adhere (or does not adhere well) to the front surface 204 of an adjacent portion of the sheet 202, even when activated (e.g., when the sheet 202 is pressed adjacent a recessed adhesive zone 230). That is, in some embodiments, the front surface 204 of the sheet 202 and the adhesive 208 can be configured such that the adhesive 208 has a greater affinity for itself (e.g., on an adjacent portion of the rear surface 206) than for the front surface 204 of the sheet 202. As such, the adhesive 208 can be configured so as not to unnecessarily wear out or lose its tackiness by adhering to other portions of the recessed adhesive binding system 200 when not in use to bind various articles of interest.

The phrase “adheres well” can generally refer to the adhesive 208 having a 90 degree peel strength, at least initially, of at least about 500 g, in some embodiments, at least about 800 g, and in some embodiments, at least about 1000 g (1 kg), when a 1-inch-(2.54 cm)-wide strip of the sheet 202 having the adhesive 208 on its rear surface 206 is peeled from an adjacent portion of the rear surface 206 of the sheet 202, having the adhesive 208 thereon (i.e., when the adhesive 208 is peeled from itself).

The phrase “does not adhere well” can generally refer to the adhesive 208 having a 90 degree peel strength, at least initially, of less than about 50 g, in some embodiments, less than about 30 g, and in some embodiments, less than about 20 g, when a 1-inch-(2.54 cm)-wide strip of the sheet 202 having the adhesive 208 on its rear surface 206 is peeled from an adjacent portion of the front surface 204 of the sheet 202.

For example, in some embodiments, an adhesive comprising composite pressure-sensitive adhesive microspheres can be employed, such as the microspheres described in U.S. Pat. No. 5,824,748, which is incorporated herein by reference in its entirety. In addition, or alternatively, in some embodiments, the front surface 204 of the sheet 202 can include a release coating in order to achieve minimal, or lack of, affinity between the adhesive 208 and the front surface 204 of the sheet 202. That is, in some embodiments, the front surface 204 of the sheet 202 can function as a release (or releasable) liner for the adhesive 208 of the recessed adhesive binding system 200. In addition, or alternatively, the front surface 204 of the sheet 202 can be glazed to enhance slidability, e.g., with itself. Examples of release coatings or low adhesion backsize (LAB) materials that can be applied to the front surface 204 of the sheet 202 can be found in U.S. Pat. Nos. 5,744,207, 5,874,144, 6,352,766, and 6,420,480, which are incorporated herein by reference in their entirety. In addition, or alternatively, in some embodiments, the front surface 204 of the sheet 202 can be configured to receive (i.e., be receptive to) ink, print, toner, marks, or the like, such that the front surface 204 can be writable, printable, and/or stainable and can serve as a writing surface, a printing surface, or the like.

FIG. 5 illustrates a recessed adhesive binding system 300 according to another embodiment of the present disclosure, wherein like numerals represent like elements. The recessed adhesive binding system 300 shares many of the same elements and features described above with reference to the illustrated embodiments of FIGS. 1-4. Accordingly, elements and features corresponding to elements and features in the illustrated embodiment of FIG. 5 are provided with the same reference numerals in the 300 series. Reference is made to the descriptions above accompanying FIGS. 1-4 for a more complete description of the features and elements (and alternatives to such features and elements) of the embodiment illustrated in FIG. 5. Any of the features described with respect to the embodiments of FIGS. 1-4 can equally be applied to the embodiment of FIG. 5.

The recessed adhesive binding system 300 is arranged in a strip configuration, and such a strip can be coupled to another surface, for example, vertically mounted to a wall, or adhered to another surface or object, to display various articles for easy access and organization. The recessed adhesive binding system 300 includes a sheet 302 having a front surface 304 and a rear surface 306, and having a pressure-sensitive adhesive 308 on the rear surface 306. As shown in FIG. 5, the sheet 302 is folded into a plurality of folded sections 320 (three are shown by way of example only), each folded section 320 having a first portion 322 and a second portion 324 separated by a fold 325, an opening 310, and a recessed adhesive zone 330. Only the second portion 324 of each folded section 320 is illustrated as including the opening 310, such that a supported article can be positioned between the folded section 320 and an adjacent portion of the sheet 302 and adhered to the second portion 324 of the folded section 320. As mentioned with respect to the embodiment of FIGS. 1-3, the recessed adhesive binding system 300 can include one or more openings 310 and recessed adhesive zones 330 along the width of the recessed adhesive binding system 300, and the narrow width that generally fits one opening 310 is shown in FIG. 5 by way of example only. In addition, in some embodiments, the first portion 322 and the second portion 324 of at least one of the folded sections 320 both include an opening 310 and a recessed adhesive zone 330.

In some embodiments, as shown in FIG. 5, the sheet 302 can be folded non-uniformly along its length (e.g., long, short, long, short, etc.), such that the folded sections 320 are arranged in a “strip” (e.g., a hanging strip) or “shingle” configuration, such that each folded section 320 is separated from an adjacent portion of the sheet 302 by a living hinge 326. As such, the recessed adhesive zone 330 of each folded section 320 is exposed to a portion of the front surface 304 of the sheet 302 that does not form another folded section 320. Such a configuration allows for the folded sections 320 to be spaced apart along the length of the sheet 302, which can facilitate organizing and displaying various articles, and which can allow for adhesive 308 to be exposed on the rear surface 306 of the recessed adhesive binding system 300 to allow the recessed adhesive binding system 300 to be mounted to another surface by the same adhesive 308 that is used to form the folded sections 320 and the recessed adhesive zones 330. In some embodiments, the recessed adhesive binding system 300 can include a release (or releasable) liner coupled to the exposed adhesive 308 on the rear surface 306 prior to use.

As a result, the living hinges 326 of the folded sections 320 can be spaced apart along the length of the sheet 302, such that the living hinges 326 are not collinear, and such that each folded section 320 can be individually rotatable about its living hinge 326. For example, when the recessed adhesive binding system 300 is mounted to a flat surface, the folded sections 320 can be pivoted about 180 degrees about the living hinge 326.

In addition, the sheet 302 includes at least some length between adjacent folded sections 320, such that a supported article 350 (e.g., a sheet of paper, as shown in FIG. 5) can be positioned between a folded section 320 and another portion of the sheet 302, and the article can be adhered to the folded section 320. Furthermore, each of the folded sections 320 includes a recessed adhesive zone 330 that is exposed to the front surface 304 of an adjacent portion of the sheet 302. As a result, when the folded sections 320 are collapsed, at least a portion of the front surface 304 of the first portion 322 of each folded section 320 is visible, and the adhesive 308 of each folded section 320 is positioned adjacent the front surface 304 of the adjacent portion of the sheet 302. Such a configuration can generally be referred to as a “shingle” configuration. In some embodiments, the shingle configuration can include the entire front surface 304 of the first portion 322 of each folded section 320 being visible, and in some embodiments, the shingle configuration can include only an outermost portion (e.g., a tip) of the front surface 304 of the first portion 322 of each folded section 320 being visible (except for the uppermost or frontmost folded section 320) when the folded sections 320 are collapsed. In some embodiments, the shingle configuration can include exposed front surfaces 304 of the first portions 322 of the folded sections 320 ranging from having only the tip visible when the folded sections 320 are collapsed to having the entire front surface 304 of the first portion 322 exposed, and in some embodiments, the plurality of folded sections 320 includes a combination of levels of exposure of the front surface 304 of the first portion 322 of each folded section 320 (e.g., not all folded sections 320 need to be exposed an identical amount).

Similar to the recessed adhesive binding system 200 of FIG. 4, the front surface 304 of the sheet 302 and/or the rear surface 306 (e.g., the adhesive 308) of the sheet 302 can be configured such that the rear surface 306 adheres (or adheres well) to the rear surface 306 of another portion of the rear surface 306 of the sheet 202, but does not adhere (or does not adhere well) to the front surface 304 of the sheet 302. As such, each folded section 320 can be configured such that it does not adhere (or does not adhere well) to the front surface 304 of the adjacent portion of the sheet 302 (e.g., even when activated or pressed). As such, the adhesive 308 can be configured so as not to unnecessarily wear out or lose its tackiness by adhering to other portions of the recessed adhesive binding system 300 when not in use to bind various articles of interest.

FIG. 6 illustrates a recessed adhesive binding system 400 according to another embodiment of the present disclosure, wherein like numerals represent like elements. The recessed adhesive binding system 400 shares many of the same elements and features described above with reference to the illustrated embodiments of FIGS. 1-4. Accordingly, elements and features corresponding to elements and features in the illustrated embodiment of FIG. 6 are provided with the same reference numerals in the 400 series.

Reference is made to the descriptions above accompanying FIGS. 1-4 for a more complete description of the features and elements (and alternatives to such features and elements) of the embodiment illustrated in FIG. 6. Any of the features described with respect to the embodiments of FIGS. 1-5 can equally be applied to the embodiment of FIG. 6.

The recessed adhesive binding system 400 includes a sheet 402 having a front surface 404 and a rear surface 406, and having a pressure-sensitive adhesive 408 on the rear surface 406. As shown in FIG. 6, the sheet 402 is folded into a plurality of folded sections 420 (three are shown by way of example only), each folded section 420 having a first portion 422 and a second portion 424 separated by a fold 425, a plurality of openings 410, and a plurality of recessed adhesive zones 430. Only the second portion 424 of each folded section 420 is illustrated as including the opening 410, such that a supported article can be positioned between first and second adjacent folded sections 420 and adhered to the second portion 424 of the first folded section 420. In addition, as shown in FIG. 6, the plurality of folded sections 420 can be arranged such that the second portion 424 of at least one of the plurality of folded sections 420 can be positioned adjacent a first portion 422 of an adjacent folded section 420.

The recessed adhesive binding system 400 is substantially similar to the recessed adhesive binding system 200 of FIG. 4, except that the sheet 402 has a longer width that can accommodate a plurality of (i.e., at least two) openings 410 and recessed adhesive zones 430 along its width. Such a configuration can allow the same folded section 420 to either accommodate multiple articles 450 along its width, or to better adhere a larger article (e.g., such as a letter-sized sheet of paper, or a larger or thicker article). As shown in FIG. 6, in some embodiments, the width of each folded section 420, and generally of the recessed adhesive binding system 400, can be sized to accommodate a sheet of paper, such as a letter-sized (or larger) sheet of paper, such that the recessed adhesive binding system 400 can be used to organize various documents, presentations, reports, or other works.

As shown in FIG. 6, the sheet 402 can include a plurality of openings 410 spaced apart along its length, and can be folded uniformly along its length (e.g., along its central or longitudinal axis), such that the folded sections 420 are arranged about a common spine or binding 435 and are separated by living hinges 426, but not by additional unfolded sections of the sheet 402. As shown in FIG. 6, in some embodiments, the living hinges 426 of the folded sections 420 can be arranged such that they are substantially collinear (e.g., or positioned directly adjacent one another) and generally fall along or create the spine or binding 435 of the recessed adhesive binding system 400. As such, the recessed adhesive binding system 400 includes a “fan,” “book,” or “binder” configuration, such that the sheet 402 includes little to no length between adjacent folded sections 420, and such that a supported article or element (e.g., a sheet of paper) can be positioned between two adjacent folded sections 420, and can be adhered to at least one of the folded sections 420 between which it is positioned.

As further shown in FIG. 6, in some embodiments, each of the folded sections 420 can be configured such that the adhesive 408 of a recessed adhesive zone 430 of one folded section 420 is exposed to the front surface 404 of an adjacent folded section 420 (i.e., except for the end folded section 420). When the folded sections 420 are collapsed upon one another (e.g., by pivoting or folding the folded sections 420 about the living hinges 426), the adhesive 408 of each folded section 420 is positioned adjacent the front surface 404 of the adjacent folded section 420. In addition, when the folded sections 420 are collapsed, the folded sections 420 can be collapsed directly on top of one another, such that only the front surface 404 of the first folded section 420 is visible. In some embodiments, the folded sections 420 can be at least slightly staggered, such that a tip or outermost portion of the front surface 404 of each folded section 420 is visible, even when all of the folded sections 420 are collapsed on top of one another.

In addition, as described with respect to the recessed adhesive binding systems of FIGS. 1-5, the front surface 404 of the sheet 402 and/or the rear surface 406 (e.g., the adhesive 408) of the sheet 402 can be configured such that the rear surface 406 adheres (or adheres well) to the rear surface 406 of another portion of the rear surface 406 of the sheet 402, but does not adhere (or does not adhere well) to the front surface 404 of the sheet 402. As such, each folded section 420 can be configured such that it does not adhere (or does not adhere well) to the front surface 404 of the adjacent portion of the sheet 402 (e.g., even when activated or pressed). As such, the adhesive 408 can be configured so as not to unnecessarily wear out or lose its tackiness by adhering to other portions of the recessed adhesive binding system 400 when not in use to bind various articles of interest.

As mentioned above, the recessed adhesive binding system 400 is arranged in a fan, book, or binder configuration, and such a binder can be used alone or can be coupled to another surface or object, to file, organize, and/or display various articles for easy access and organization. The recessed adhesive binding system 400 is shown by way of example only as having two bound and supported articles 450 (i.e., two sheets of paper), each coupled between a first and second folded section 420 and adhered to the second portion 424 of the first folded section 420. In addition, the recessed adhesive binding system 400 is illustrated as being coupled to, or forming a portion of, a hanging file 460. That is, the recessed adhesive binding system 400 can include, or be coupled to, one or more coupling mechanisms 465 (e.g., hooks), for example, that allow the recessed adhesive binding system 400 to be positioned in a file drawer or file cabinet, along with the articles 450 coupled or bound thereto. For example, one or more of the folded sections 420 can be coupled to, or include, the coupling mechanisms 465; the binding 435 can be coupled to, or can include, the coupling mechanisms 465; or a combination thereof.

FIG. 7 illustrates a recessed adhesive binding system 500 according to another embodiment of the present disclosure, wherein like numerals represent like elements. The recessed adhesive binding system 500 shares many of the same elements and features described above with reference to the illustrated embodiments of FIGS. 1-4 and 6. Accordingly, elements and features corresponding to elements and features in the illustrated embodiment of FIG. 7 are provided with the same reference numerals in the 500 series. Reference is made to the descriptions above accompanying FIGS. 1-4 and 6 for a more complete description of the features and elements (and alternatives to such features and elements) of the embodiment illustrated in FIG. 7. Any of the features described with respect to the embodiments of FIGS. 1-6 can equally be applied to the embodiment of FIG. 7.

The recessed adhesive binding system 500 includes a sheet 502 having a front surface 504 and a rear surface 506, and having a pressure-sensitive adhesive 508 on the rear surface 506. As shown in FIG. 7, the sheet 502 is folded into a plurality of folded sections 520 (three are shown by way of example only), each folded section 520 having a first portion 522 and a second portion 524 separated by a fold 525, a plurality of openings 510, and a plurality of recessed adhesive zones 530.

The recessed adhesive binding system 500 is substantially similar to the recessed adhesive binding system 400 of FIG. 6, except that unlike the recessed adhesive binding system 400 of FIG. 6, in the recessed adhesive binding system 500 of FIG. 7, the first portion 522 and the second portion 524 of each folded section 520 include a plurality of openings 510 positioned along its width (e.g., equally spaced along the width), such that a supported article 550 (e.g., two sheets of paper are shown by way of example only) can be positioned between first and second adjacent folded sections 520 and adhered to both the second portion 524 of the first folded section 520 and the first portion 522 of the second folded section 520. Such embodiments can allow for enhanced adherence of the supported article(s) 550 to the recessed adhesive binding system 500.

In addition, as shown in FIG. 7, in some embodiments, when both the first portion 522 and the second portion 524 of the folded sections 520 include recessed adhesive zones 530, the openings 510 and recessed adhesive zones 530 can be arranged on the first and second portions 522 and 524 such that the recessed adhesive zones 530 do not overlap. In this way, the first portion 522 of a folded section 520 can include a plurality of first openings 510a and first recessed adhesive zones 530a positioned along its width, and the second portion 524 of the folded section 520 can include a plurality of second openings 510b and second recessed adhesive zones 530b positioned along its width. The first openings 510a and the first recessed adhesive zones 530a can be equally spaced apart along the width of the folded section 520, and the second openings 510b and the second recessed adhesive zone 530b can be equally spaced apart along the width of the folded section 520. In addition, the first and second openings 510a and 510b and the first and second recessed adhesive zones 530a and 530b can be arranged such that each first opening 510a and first recessed adhesive zone 530a is spaced a distance along the width from at least one second opening 510b and second recessed adhesive zone 530b. As a result, a supported article 550 can be adhered to both the second portion 524 of one folded section 520 and the first portion 522 of an adjacent folded section 520 (e.g., when the recessed adhesive zones 530) are activated, but the first recessed adhesive zones 530a will not become adhered to the second recessed adhesive zones 530b of an adjacent folded section 520 when no supported article 550 is present between them and, for example, when the folded sections 520 are collapsed on top of one another.

Such a configuration can also be beneficial, for example, when the front surface 504 of the sheet 502 and/or the adhesive 508 is configured such that the adhesive 508 has greater affinity for itself than for the front surface 504 of the sheet 502.

As shown in FIG. 7, the sheet 502 can include a plurality of openings 510 spaced apart along its length, and can be folded uniformly along its length (e.g., along its central or longitudinal axis), such that the folded sections 520 are arranged about a common spine or binding 535 and are separated by living hinges 526, but not by additional unfolded sections of the sheet 502. As shown in FIG. 7, in some embodiments, the living hinges 526 of the folded sections can be arranged such that they are substantially collinear (e.g., or positioned directly adjacent one another) and generally fall along or create the spine or binding 535 of the recessed adhesive binding system 500. As such, the recessed adhesive binding system 500 includes a “fan,” “book,” or “binder” configuration, such that the sheet 502 includes little to no length between adjacent folded sections 520, and such that a supported article or element (e.g., a sheet of paper) can be positioned between two adjacent folded sections 520, and can be adhered to both of the folded sections 520 between which it is positioned.

As further shown in FIG. 7, in some embodiments, each of the folded sections 520 can be configured such that the adhesive 508 of a recessed adhesive zone 530 of one folded section 520 is exposed to the front surface 504 of an adjacent folded section 520 (i.e., except for the end folded section 520). For example, the first recessed adhesive zones 530a can be exposed to the front surface 504 of the second portion 524 of an adjacent folded section 520, and the second recessed adhesive zones 530b can be exposed to the front surface 504 of the first portion 522 of an adjacent folded section 520. In addition, when the folded sections 520 are collapsed, the folded sections 520 can be collapsed directly on top of one another, such that only the front surface 504 of the first folded section 520 is visible.

As mentioned above, the recessed adhesive binding system 500 is arranged in a fan, book, or binder configuration, and such a binder can be used alone or can be coupled to another surface or object, to file, organize, and/or display various articles for easy access and organization. The recessed adhesive binding system 500 is shown by way of example only as having two bound and supported articles 550 (i.e., two sheets of paper), each coupled between a first and second folded section 520 and adhered to both the second portion 524 of the first folded section 520 and the first portion 522 of the second folded section 520. In addition, the recessed adhesive binding system 500 illustrated as being coupled to, or forming a portion of, a file folder 560. By way of example only, one or more of the folded sections 520 can be coupled to, or include, at least a portion of the file folder 560; the binding 535 can be coupled to, or can include, at least a portion of the file folder 560; or a combination thereof.

FIG. 8 illustrates the recessed adhesive binding system 500 of FIG. 7, but rather than being coupled to, or forming a portion of, the file folder 560, the recessed adhesive binding system 500 is shown mounted to a vertical surface 560′ (e.g., a wall) and used to organize and/or display various articles. By way of example only, the recessed adhesive binding system 500 in FIG. 8 is illustrated as including envelopes 550′ bound and/or displayed in the recessed adhesive binding system 500.

As shown in FIG. 8, in some embodiments, the envelopes 550′ can be coupled to the recessed adhesive binding system 500 in such a way that the flap of the envelope is in a closed position, thereby allowing the envelopes to serve as pockets in the recessed adhesive binding system 500 to hold additional small and lightweight articles even when turned upside-down. Such lightweight articles can include, but are not limited to, one or more of coins, stamps, paperclips, thumbtacks, writing utensils, erasers, small tools (e.g., small screwdrivers or Allen wrenches), fasteners (e.g., nails, screws, brads, rivets, etc.), art supplies (e.g., crayons, colored pencils, paintbrushes, etc.), coupons, bills, other suitable articles, or combinations thereof.

The recessed adhesive binding system 500 can be coupled to the vertical surface 560′ using a variety of known means, such as adhesives, nails, removable adhesive systems available under the trade designation “COMMAND” from 3M Company, St. Paul, Minn., or the like, or combinations thereof.

As shown in FIG. 8, in some embodiments, supported articles (e.g., the envelopes 550′) in the recessed adhesive binding system 500 can be flipped upside-down to access and/or view a supported article underneath it without removing the articles from the recessed adhesive binding system 500.

By way of example only, the recessed adhesive binding system 500 is illustrated in FIG. 8 as being horizontally oriented while bound to a vertical surface. However, it should be understood that the recessed adhesive binding system 500 can instead be vertically oriented, or can be positioned in another orientation while mounted to the vertical surface 560′, without departing from the spirit and scope of the present disclosure.

FIG. 9 illustrates a method of making a recessed adhesive binding system according to one embodiment of the present disclosure. As shown in FIG. 9, in a first step 10A, the method 10 can include providing a sheet 602 having a front surface 604 and a rear surface 606, and having a pressure-sensitive adhesive 608 on the rear surface 606. In a second step 10B, the method 10 can further include forming at least one opening 610 through the sheet 602 (e.g., by punching, cutting, stamping, other suitable means, or combinations thereof). In a third step 10C, the method 10 can further include folding the sheet 602 (e.g., in a zig-zag pattern or configuration) to form at least one folded section 620, such that each folded section includes a first portion 622 of the sheet 602 and a second portion 624 of the sheet 602 separated by a fold 625. As illustrated in a fourth step 10D of FIG. 9, folding the sheet 602 can also include forming the folded sections 620, such that the rear surface 606 of the first portion 622 of each folded section 620 is adhered to the rear surface 606 of the second portion 624 of the folded section 620, and such that one or both of the first portion 622 and the second portion 624 includes at least one opening 610. As a result, when the first portion 622 and the second portion 624 are pressed and adhered together, the pressure-sensitive adhesive 608 is exposed across the at least one opening 610 and recessed from the front surface 604 of the sheet 602, forming at least one recessed adhesive zone 630 in the at least one folded section 620.

By way of example only, the openings 610 and the recessed adhesive zones 630 are arranged just like that of the recessed adhesive binding system 500, i.e., such that the first portion 622 and the second portion 624 of each folded section 620 both include recessed adhesive zones 630. However, it should be understood that the openings 610 can be arranged along the length and width of the sheet 602 such that other configurations are possible, such as the recessed adhesive binding system 400 of FIG. 6. In addition, the folding can be controlled, such that the folded sections 620 are in a book configuration such as the recessed adhesive binding system 600 formed in step 10D of FIG. 9; the shingle configuration of the recessed adhesive binding system 300 of FIG. 5; another suitable configuration; or a combination thereof. For example, folding the sheet 602 uniformly (e.g., such that the folds 625 are evenly spaced and the living hinges 626 are evenly spaced along the length of the sheet 602) can result in a book configuration, whereas folding the sheet 602 non-uniformly can result in a slightly staggered configuration, a shingle configuration, or another configuration. In addition, the size and shape of the sheet 602 can be controlled to determine whether the resulting recessed adhesive binding system 600 has a length and width having recessed adhesive zones 630 as shown in step 10D of FIG. 9, or has a narrow width sized to accommodate one opening 610, such as the recessed adhesive binding system 300 of FIG. 5.

The recessed adhesive binding systems 100, 200, 300, 400, 500 and 600 are each illustrated by way of example only, and it should be understood that a variety of recessed adhesive binding systems employing various combinations of the features and elements of the recessed adhesive binding systems 100, 200, 300, 400, 500 and 600 also fall within the spirit and scope of the present disclosure. In addition, the method 10 can be specifically tailored to make any of the recessed adhesive binding systems 100, 200, 300, 400, 500 and 600, as described above. In addition, any combination of the features and elements described above and illustrated in FIGS. 1-9 can be employed in one recessed adhesive binding system of the present disclosure.

The following is a description of various embodiments of the present disclosure.

### Embodiments

Embodiment 1 is a recessed adhesive binding system, the system comprising: a sheet having a front surface and a rear surface, and having a pressure-sensitive adhesive on the rear surface;
at least one opening formed through the sheet; and
at least one folded section formed in the sheet, the at least one folded section including a first portion of the sheet and a second portion of the sheet separated by a fold, wherein the rear surface of the first portion is adhered to the rear surface of the second portion, and wherein at least one of the first portion and the second portion includes at least one opening, such that when the first portion and the second portion are adhered together, the pressure-sensitive adhesive is exposed across the at least one opening and recessed from the front surface of the sheet, forming at least one recessed adhesive zone in the at least one folded section.

Embodiment 2 is the system of embodiment 1, wherein the sheet has a length and a width, wherein the at least one opening includes at least two openings, wherein the at least two openings are spaced apart along the length of the sheet, and wherein the width is dimensioned to accommodate one opening.

Embodiment 3 is the system of embodiment 1, wherein the sheet has a length and a width, wherein the at least one opening includes at least two openings, wherein the at least two openings are spaced apart along the length of the sheet and along the width of the sheet, and wherein the length and the width are each dimensioned to accommodate at least two openings.

Embodiment 4 is the system of any of embodiments 1-3, wherein the at least one folded section is at least two folded sections, and wherein the at least two folded sections are spaced apart along a length of the sheet, such that the pressure-sensitive adhesive on the rear surface of the sheet between the at least two folded sections is exposed.

Embodiment 5 is the system of any of embodiments 1-4, wherein the at least one folded section is a plurality of folded sections arranged in a shingle configuration, such that the pressure-sensitive adhesive on the rear surface of the sheet between adjacent folded sections is exposed.

Embodiment 6 is the system of embodiment 4 or 5, wherein the exposed rear surface between adjacent folded sections is configured to be adhered to a mounting surface.

Embodiment 7 is the system of any of embodiments 1-6, wherein the at least one folded section is a plurality of folded sections, and wherein the plurality of folded sections are arranged in a book configuration, such that the sheet includes little to no length between adjacent folded sections.

Embodiment 8 is the system of any of embodiments 1-7, wherein the recessed adhesive zone of the at least one folded section is exposed to a portion of the front surface of the sheet.

Embodiment 9 is the system of embodiment 8, wherein the portion of the front surface of the sheet to which the recessed adhesive zone is exposed does not form a portion of a folded section.

Embodiment 10 is the system of embodiment 8, wherein the portion of the front surface of the sheet to which the recessed adhesive zone is exposed forms the first portion of an adjacent folded section.

Embodiment 11 is the system of any of embodiments 1-10, wherein the at least one folded section includes at least two folded sections, and wherein the at least two folded sections are arranged in the sheet such that a recessed adhesive zone of a first folded section is exposed to the front surface of the first portion of an adjacent folded section.

Embodiment 12 is the system of any of embodiments 1-11, wherein the first portion of the at least one folded section includes a plurality of first recessed adhesive zones spaced apart along a width of the sheet, wherein the second portion of the at least one folded section includes a plurality of second recessed adhesive zones spaced apart along the width of the sheet, and wherein each first recessed adhesive zone is spaced a distance along the width of the sheet from a second recessed adhesive zone.

Embodiment 13 is the system of any of embodiments 1-12, wherein the at least one folded section includes at least two folded sections and is arranged in a binder configuration, such that a supported article can be positioned between the second portion of a first folded section and the first portion of an adjacent second folded section.

Embodiment 14 is the system of embodiment 13, wherein the supported article is bound between adjacent folded sections when the at least one recessed adhesive is activated.

Embodiment 15 is the system of embodiment 13 or 14, wherein at least one of the second portion of the first folded section and the first portion of the second folded section includes the at least one recessed adhesive zone.

Embodiment 16 is the system of any of embodiments 1-15, further comprising a living hinge defined between the at least one folded section and a portion of the sheet, such that the folded section can pivot about the living hinge.

Embodiment 17 is the system of embodiment 16, further comprising a supported article positioned between the at least one folded section and the portion of the sheet, the supported article adhered to the at least one recessed adhesive zone.

Embodiment 18 is the system of any of embodiments 1-17, wherein the at least one folded section is a plurality of folded sections, wherein each of the plurality of folded sections defines a living hinge, and wherein the living hinge of each of the plurality of folded sections is positioned directly adjacent the living hinge of an adjacent folded section.

Embodiment 19 is the system of embodiment 18, further comprising a supported article positioned between two adjacent folded sections and adhered to the at least one recessed adhesive zone.

Embodiment 20 is the system of any of embodiments 1-19, wherein the at least one opening does not extend across the fold of the at least one folded section.

Embodiment 21 is a recessed adhesive binding system, the system comprising:
a sheet having a front surface and a rear surface, and having a pressure-sensitive adhesive on the rear surface, the sheet having a length and a width;
a plurality of openings formed through the sheet; and
a plurality of folded sections formed in the sheet, each of the plurality of folded sections including a first portion of the length of the sheet and a second portion of the length of the sheet separated by a fold, the fold extending along the width of the sheet, wherein the rear surface of the first portion is adhered to the rear surface of the second portion, and wherein at least one of the first portion and the second portion of each folded section includes at least one opening positioned along its width, such that when the first portion and the second portion are adhered together, the pressure-sensitive adhesive is exposed across the at least one opening and recessed from the front surface of the sheet, forming at least one recessed adhesive zone along the width of each of the plurality of folded sections, wherein the plurality of folded sections are arranged such that the second portion of at least one of the plurality of folded sections is positioned adjacent a first portion of an adjacent folded section.

Embodiment 22 is a file folder comprising the recessed adhesive binding system of embodiment 21.

Embodiment 23 is a hanging file comprising the recessed adhesive binding system of embodiment 21.

Embodiment 24 is the system of any of embodiments 21-23, further comprising a supported article positioned between adjacent folded sections and adhered to the at least one recessed adhesive zone.

Embodiment 25 is the system of embodiment 24, wherein the supported article is an envelope.

Embodiment 26 is the system of embodiment 24 or 25, wherein the supported article is a sheet of paper.

Embodiment 27 is the system of any of embodiments 21-26, wherein the plurality of folded sections are arranged such that when the plurality of folded sections is collapsed, the front surface of the first portion of one of the plurality of folded sections is visible.

Embodiment 28 is a recessed adhesive binding system, the system comprising:
a sheet having a front surface and a rear surface, and having a pressure-sensitive adhesive on the rear surface, the sheet having a length and a width;
a plurality of openings formed through the sheet; and
a plurality of folded sections formed in the sheet, each of the plurality of folded sections including a first portion of the length of the sheet and a second portion of the length of the sheet separated by a fold, the fold extending along the width of the sheet, wherein the rear surface of the first portion is adhered to the rear surface of the second portion, and wherein at least one of the first portion and the second portion of each folded section includes at least one opening positioned along its width, such that when the first portion and the second portion are adhered together, the pressure-sensitive adhesive is exposed across the at least one opening and recessed from the front surface of the sheet, forming at least one recessed adhesive zone along the width of each of the plurality of folded sections, each of the plurality of folded sections defining a living hinge between the folded section and another portion of the sheet, wherein at least two adjacent folded sections of the plurality of folded sections are spaced a distance apart along the length of the sheet, such that the rear surface of the sheet between the at least two adjacent folded sections is exposed.

Embodiment 29 is the system of embodiment 28, wherein the exposed rear surface between adjacent folded sections is configured to be adhered to a mounting surface.

Embodiment 30 is a hanging strip comprising the recessed adhesive binding system of embodiment 28 or 29.

Embodiment 31 is the system of any of embodiments 28-30, further comprising a supported article positioned between one of the plurality of folded sections and the front surface of an adjacent portion of the sheet.

Embodiment 32 is the system of embodiment 31, wherein the supported article is at least one of a sheet of paper and an envelope.

Embodiment 33 is the system of any of embodiments 28-32, wherein the plurality of folded sections are arranged such that when the plurality of folded sections is collapsed, the front surface of the first portion of each of the plurality of folded sections is visible.

Embodiment 34 is a method of making a recessed adhesive binding system, the method comprising:
providing a sheet having a front surface and a rear surface, and having a pressure-sensitive adhesive on the rear surface;
forming at least one opening through the sheet;
folding the sheet to form at least one folded section, the at least one folded section including a first portion of the sheet and a second portion of the sheet separated by a fold, wherein the rear surface of the first portion is adhered to the rear surface of the second portion, and wherein at least one of the first portion and the second portion includes at least one opening, such that when the first portion and the second portion are adhered together, the pressure-sensitive adhesive is exposed across the at least one opening and recessed from the front surface of the sheet, forming at least one recessed adhesive zone in the at least one folded section.

Embodiment 35 is the method of embodiment 34, wherein the at least one folded section is a plurality of folded sections, and wherein folding the sheet to form at least one folded section includes folding the sheet in a zig-zag pattern.

Embodiment 36 is the method of embodiment 34 or 35, wherein each of the plurality of folded sections includes a living hinge defined between the folded section and a portion of the sheet, and wherein folding the sheet includes folding the sheet uniformly, such that the folds and the living hinges of the plurality of folded sections are spaced an equal distance apart.

Embodiment 37 is the method of embodiment 34 or 35, wherein folding the sheet includes folding the sheet non-uniformly.

Embodiment 38 is the method of any of embodiments 34-37, wherein forming at least one opening through the sheet includes arranging the at least one opening such that the first portion and the second portion of the at least one folded section each include the at least one recessed adhesive zone.

Embodiment 39 is the method of any of embodiments 34-37, wherein forming at least one opening through the sheet includes arranging the at least one opening such that only the second portion of the at least one folded section includes the at least one recessed adhesive.

Embodiment 40 is the system of any of embodiments 1-33 or the method of any of embodiments 34-39, wherein the sheet is a single layer.

Embodiment 41 is the system of any of embodiments 1-33 and 40 or the method of any of embodiments 34-40, wherein the sheet is formed of paper.

Embodiment 42 is the system of any of embodiments 1-33 and 40-41 or the method of any of embodiments 34-41, wherein the front surface of the sheet includes a releasable coating.

Embodiment 43 is the system of any of embodiments 1-33 and 40-42 or the method of any of embodiments 34-42, wherein the pressure-sensitive adhesive is configured to have greater affinity for itself than for the front surface of the sheet.

Embodiment 44 is the system of any of embodiments 1-33 and 40-43 or the method of any of embodiments 34-43, wherein the rear surface of the sheet is configured to adhere to another portion of the rear surface of the sheet but not to the front surface of the sheet.

The embodiments described above and illustrated in the figures are presented by way of example only and are not intended as a limitation upon the concepts and principles of the present disclosure. As such, it will be appreciated by one having ordinary skill in the art that various changes in the elements and their configuration and arrangement are possible without departing from the spirit and scope of the present disclosure. Various features and aspects of the present disclosure are set forth in the following claims.

1. A recessed adhesive binding system, the system comprising:
a sheet having a front surface and a rear surface, and having a pressure-sensitive adhesive on the rear surface;
at least one opening formed through the sheet; and
at least one folded section formed in the sheet, the at least one folded section including a first portion of the sheet and a second portion of the sheet separated by a fold, wherein the rear surface of the first portion is adhered to the rear surface of the second portion, and wherein at least one of the first portion and the second portion includes at least one opening, such that when the first portion and the second portion are adhered together, the pressure-sensitive adhesive is exposed across the at least one opening and recessed from the front surface of the sheet, forming at least one recessed adhesive zone in the at least one folded section.

2. The system of claim 1, wherein the at least one folded section is at least two folded sections, and wherein the at least two folded sections are spaced apart along a length of the sheet, such that the pressure-sensitive adhesive on the rear surface of the sheet between the at least two folded sections is exposed.

3. The system of claim 1, wherein the at least one folded section is a plurality of folded sections arranged in a shingle configuration, such that the pressure-sensitive adhesive on the rear surface of the sheet between adjacent folded sections is exposed.

4. The system of claim 1, wherein the at least one folded section is a plurality of folded sections, and wherein the plurality of folded sections are arranged in a book configuration, such that the sheet includes little to no length between adjacent folded sections.

5. The system of claim 1, wherein the recessed adhesive zone of the at least one folded section is exposed to a portion of the front surface of the sheet.

6. The system of claim 5, wherein the portion of the front surface of the sheet to which the recessed adhesive zone is exposed does not form a portion of a folded section.

7. The system of claim 5, wherein the portion of the front surface of the sheet to which the recessed adhesive zone is exposed forms the first portion of an adjacent folded section.

8. The system of claim 1, wherein the at least one folded section includes at least two folded sections, and wherein the at least two folded sections are arranged in the sheet such that a recessed adhesive zone of a first folded section is exposed to the front surface of the first portion of an adjacent folded section.

9. The system of claim 1, wherein the first portion of the at least one folded section includes a plurality of first recessed adhesive zones spaced apart along a width of the sheet, wherein the second portion of the at least one folded section includes a plurality of second recessed adhesive zones spaced apart along the width of the sheet, and wherein each first recessed adhesive zone is spaced a distance along the width of the sheet from a second recessed adhesive zone.

10. The system of claim 1, further comprising a living hinge defined between the at least one folded section and a portion of the sheet, such that the folded section can pivot about the living hinge.

11. A method of making a recessed adhesive binding system, the method comprising:
providing a sheet having a front surface and a rear surface, and having a pressure-sensitive adhesive on the rear surface;
forming at least one opening through the sheet;
folding the sheet to form at least one folded section, the at least one folded section including a first portion of the sheet and a second portion of the sheet separated by a fold, wherein the rear surface of the first portion is adhered to the rear surface of the second portion, and wherein at least one of the first portion and the second portion includes at least one opening, such that when the first portion and the second portion are adhered together, the pressure-sensitive adhesive is exposed across the at least one opening and recessed from the front surface of the sheet, forming at least one recessed adhesive zone in the at least one folded section.

12. The method of claim 11, wherein forming at least one opening through the sheet includes arranging the at least one opening such that the first portion and the second portion of the at least one folded section each include the at least one recessed adhesive zone.

13. The method of claim 11, wherein forming at least one opening through the sheet includes arranging the at least one opening such that only the second portion of the at least one folded section includes the at least one recessed adhesive.

14. The system of claim 1, wherein the pressure-sensitive adhesive is configured to have greater affinity for itself than for the front surface of the sheet.

15. The method of claim 11, wherein the pressure-sensitive adhesive is configured to have greater affinity for itself than for the front surface of the sheet.
